(19) United States
(12) Patent Application Publication
(10) Pub. No.: US 2007/0205223 A1
(43) Pub. Date: Sep. 6, 2007

(54) Personal Protection Device

(76) Inventor: Kathryn E. Hansen, Lenexa, KS (US)

Correspondence Address: ADVANTIA LAW GROUP, 9035 SOUTH 1300 EAST, SUITE 200, SANDY, UT, 84094, US

(21) Appl. No.: 11/308,091

(22) Filed: Mar. 6, 2006

(51) Int. Cl. B67D 1/07

(52) U.S. Cl. 222/192; 116/DIG. 44; 222/183

(57) ABSTRACT

A personal protection device for emitting a loud noise and/or directing a spray toward an attacking person, including a sound producing canister, a deterrent spray canister, and a trigger corresponding with both the sound producing canister and the deterrent spray canister, such that when the trigger is depressed, the spray canister releases a deterrent spray, and the sound producing canister releases a sound. The personal protection device may include a cap that locks over the trigger for protecting the trigger from being accidentally pushed.

### BACKGROUND OF THE INVENTION

1. Field of the Invention

The present invention relates generally to personal protection devices and, more particularly, to personal protection devices with a deterrence and a notification.

2. Description of the Related Art

The art of deterring an attack and/or notifying others of a possible attack include several available technologies for accomplishing these tasks. All of the following U.S. Patents and Patent application Publications are herein incorporated by a reference.

For example, in U.S. Pat. No. 5,859,588, Malone discloses a personal protection device including a handbag with pepper spray and air siren canisters stored therein, a button on the handle of the handbag activating a switch to actuate the canisters, the pepper spray being dispersed through a hole in the handle, the air siren being directed through a vent in the handbag, and including a safety lock in the handle to prevent accidental dispersion of the canisters.

Further, Cranford discloses, in U.S. Pat. No. 5,629,679 a portable personal security device of compact size capable of being carried in a pocket or purse or the like, has a pistol-like configuration with a handgrip portion and a barrel portion. The device includes a noxious chemical which may be discharged to fend off an attack by an assailant, and an audible alarm which may be sounded to attract attention and/or to discourage an attacker. Further, a light is provided on the device so that it can be used as a flashlight. A plurality of finger-receiving openings are formed in the handgrip portion to effect a secure grip on the device and make it difficult to dislodge from the hand of the user. These openings also assist in quickly and properly orienting the device. An actuator for energizing the light, the chemical discharge and the audible alarm includes structure which enables sequential activation of these devices. A timer in the audible alarm circuit maintains the audible alarm activated for a predetermined time after the actuator is released, and a shock sensor is operative to activate the audible alarm in the event of an impact against the device.

Finally, Morris discloses, in U.S. Pat. No. 4,223,804, a portable defense device combining a flashlight with a renewable, interchangeable cylinder containing compressed gas which may be used to generate a noise, to disperse dye and/or an odoriferous spray. The compressed gas may be stored in a canister which may take the form of a spray can having the typical articulated dispensing nozzle which is then received in an articulated throat assembly displaced to release the contents by a pivoted trigger engaging a pivoted arm assembly. In the normal state the trigger is aligned over the exit opening of the throat, thus protecting the dispensing nozzle from inadvertent release, and when released the trigger aligns to engage the arm.

What is needed is a personal protection device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available personal protection devices. According to one embodiment, the present invention has been developed to provide a personal protection device, comprising a sound producing canister, a deterrent spray canister, and a trigger corresponding with both the sound producing canister and the deterrent spray canister, such that when the trigger is depressed, the spray canister releases a deterrent spray, and the sound producing canister releases a sound.

The personal protection device may further include a trigger cap. The trigger cap may be mounted to the personal protection device by a hinge. The trigger cap may include a locking device for holding the trigger cap in a closed position. The locking device may include a barb.

The personal protection device may further include a spray nozzle.

The personal protection device may further include a sound nozzle.

The personal protection device may further include a sound nozzle and a spray nozzle.

In yet another embodiment, the current invention may include a personal protection device, consisting essentially of a sound producing canister, a deterrent spray canister, and a trigger corresponding with both the sound producing canister and the deterrent spray canister, such that when the trigger is depressed, the spray canister releases a deterrent spray, and the sound producing canister releases a sound.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of the personal protection device according to one embodiment of the present invention;

FIG. 2 illustrates a side plan view of the personal protection device according to one embodiment of the present invention;

FIG. 3 illustrates a side cross-sectional view of the personal protection device according to one embodiment of the present invention; and

FIG. 4 illustrates a side cross-sectional view of the personal protection device according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

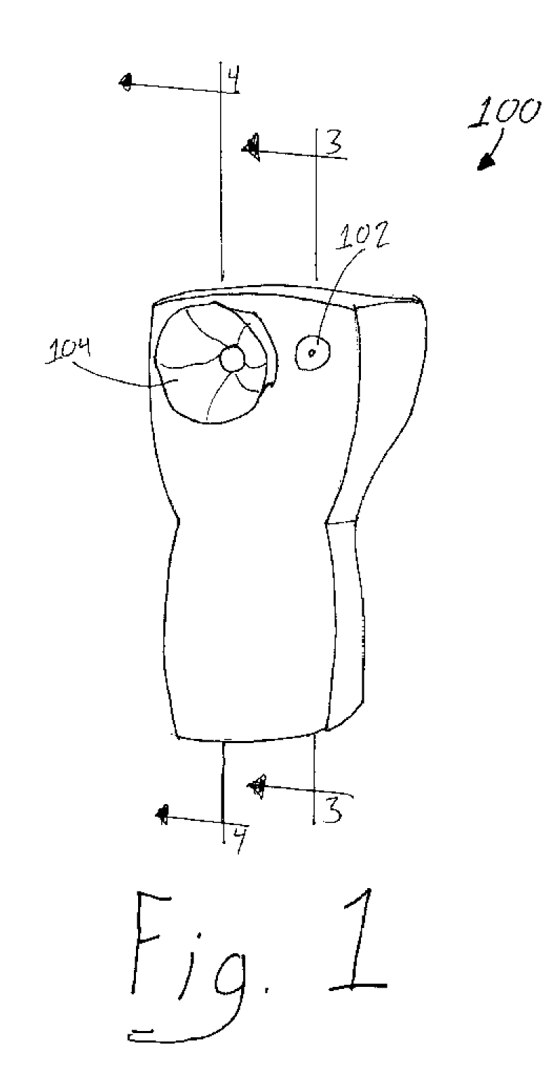

FIG. 1 illustrates a perspective view of the personal protection device 100 according to one embodiment of the present invention. The illustrated personal protection device 100 may include a sound nozzle 104 and a spray nozzle 102. The sound nozzle 104 may be used to broadcast a sound. The spray nozzle 102 may be used to direct a spray. The personal protection device 100 of the present invention may be used to deter an attacking person, and/or notify others of an attack. The personal protection device 100 may be used to broadcast a loud noise and/or direct a spray in the direction of the attacker.

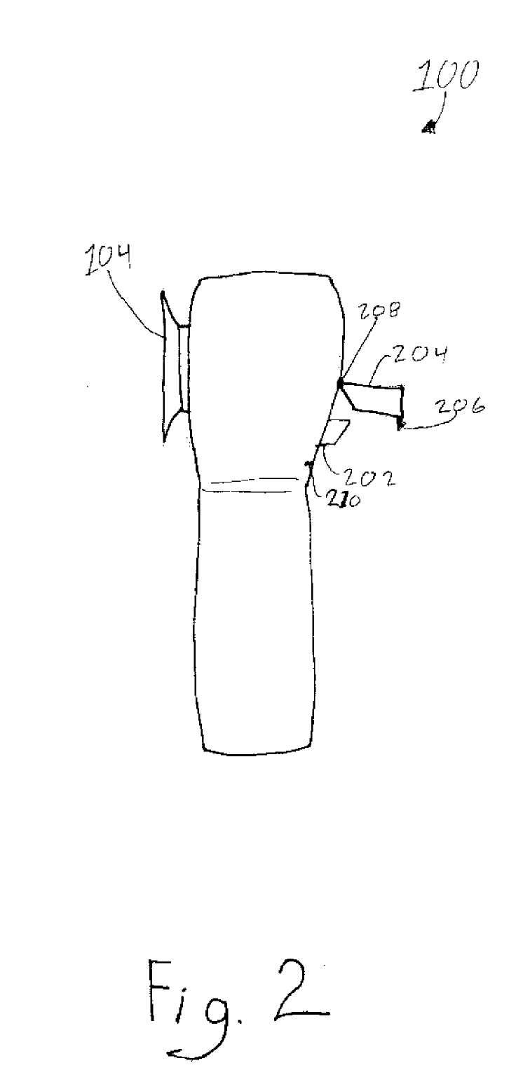

FIG. 2 illustrates a side plan view of the personal protection device 100 according to one embodiment of the present invention. The illustrated embodiment includes a trigger 202. When pushed, the trigger 202 may cause the personal protection device 100 to broadcast a loud noise and/or direct a spray toward an attacker. In one embodiment, the trigger 202 is angled so that it must be pushed upwardly to cause the personal protection device 100 to broadcast a loud noise and/or direct a spray toward an attacker.

The personal protection device 100 may include a cap 204 that may snap over the trigger 202. The cap 204 may protect the trigger 202 from being accidentally pushed. The cap 204 may include a lock device 206 with a barb that corresponds to a hole, aperture, or void 210 in the personal protection device 100. In this configuration, the cap may be opened by pushing upwardly on the side of the cap connected to the lock device 206, thus unhooking the barb from the aperture 210, and allowing the cap 204 to be opened, and the trigger 202 accessed. Further, there may be a hinge 208 that connects another end of the cap 204 to the personal protection device 100. The hinge 208 may allow the cap 204 to rotate around the hinge 208 such that the trigger 202 may be accessed. The trigger 202, cap 204, and aperture 210 may be located on a side of the personal protection device that is opposite of the sound nozzle 104.

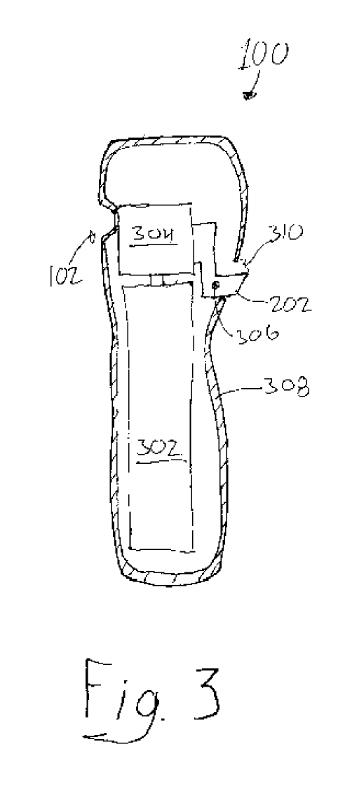

FIG. 3 illustrates a cross sectional view of the personal protection device. The illustrated embodiment includes a housing 308. In the housing is held a spray canister 302. The spray canister 302 may include a pressurized substance used to deter attackers. The substance may include any known in the art, such as, for example, tear gas, pepper spray, bear spray, dog spray, and the like. The canister 302 may have a cap 304. The spray cap 304 may be configured to direct the spray through the spray nozzle 102. The cap 304 may be configured such that when it is tilted in one direction, the spray is released throughout the nozzle 102.

The personal protection device 100 may include a trigger 202. The trigger may include a pivot point 306 about which it may pivot. One end of the trigger 202 may contact the spray cap 304 such that when the other end of the trigger 202 is pushed upwardly into an aperture 310 in the housing 308, the end that is not pushed pushes the spray cap 304 such that the spray is released through the spray nozzle 102. Thus, in use, the user need only push the trigger 202 toward the aperture 310, and the spray will be released through the spray nozzle 102.

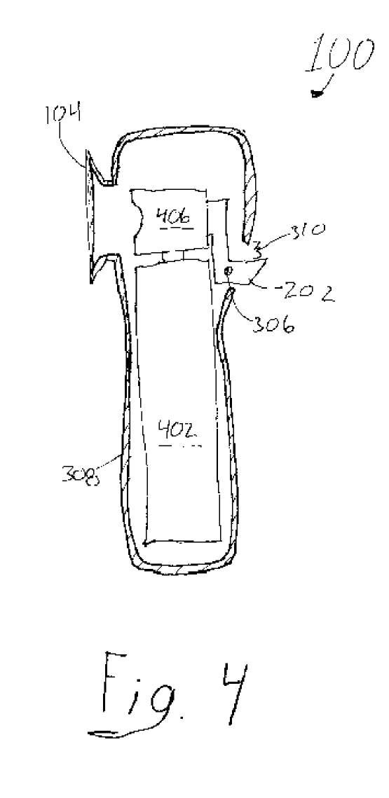

FIG. 4 illustrates a cross-sectional view of one embodiment of the personal protection device. Illustrated in this figure is a housing 308 which includes a sound canister 402. The sound canister 402 may include a pressurized gas. The sound canister 402 may include a sound cap 406 that, when it is pushed to one side, releases the pressurized gas through a nozzle to produce a loud sound. The sound may then be directed from the sound cap 406 through the sound nozzle 104. As with FIG. 3, the trigger 202 may include a pivot point 306, and function in the same manner. Thus, when the user pushes the trigger 202 toward the aperture 310, a loud sound is made by the sound canister 402 acting in conjunction with the sound cap 406. The loud sound may then be directed outwardly through the sound nozzle 104.

In one embodiment, the personal protection device of the present invention may include both a spray canister 302 with its spray cap 304, and a sound canister 402 with its sound cap 406. The trigger 202 may coordinate with both the spray cap 304 and the sound cap 406 such that when the trigger 202 is pushed toward the aperture 310, the spray is released and the sound is released. Thus, when directed toward an attacker, the personal protection device 100 both sprays the deterrent spray at the attacker and broadcasts the loud noise in the direction of the attacker.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

It is expected that there could be numerous variations of the design of this invention. For example, in one embodiment, the personal protection device includes a carrying case. The carrying case may be formed of any flexible material, such as, for example, leather, plastic, woven materials, non-woven materials, and the like. The carrying case may cover all of the personal protection device except for the nozzles and the trigger and/or trigger cap. The carrying case may include a coupling device for securing the personal protection device to another object. For example, the carrying case may include a belt-clip for removeably securing the personal protection device to a persons belt. In another embodiment, the carrying case may include a purse-clip for removeably securing the personal protection device to a purse strap.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A personal protection device, comprising:
a sound producing canister;
a deterrent spray canister; and
a trigger corresponding with both the sound producing canister and the deterrent spray canister, such that when the trigger is depressed, the spray canister releases a deterrent spray, and the sound producing canister releases a sound.

2. The personal protection device of claim 1, further comprising a trigger cap.

3. The personal protection device of claim 2, wherein the trigger cap is mounted to the personal protection device by a hinge.

4. The personal protection device of claim 2, wherein the trigger cap includes a locking device for holding the trigger cap in a closed position.

5. The personal protection device of claim 4, wherein the locking device includes a barb.

6. The personal protection device of claim 1, further comprising a spray nozzle.

7. The personal protection device of claim 1, further comprising a sound nozzle.

8. The personal protection device of claim 1, further comprising a sound nozzle and a spray nozzle.

9. A personal protection device, consisting essentially of:
a sound producing canister;
a deterrent spray canister; and
a trigger corresponding with both the sound producing canister and the deterrent spray canister, such that when the trigger is depressed, the spray canister releases a deterrent spray, and the sound producing canister releases a sound.
